(19) United States
(12) Patent Application Publication
(10) Pub. No.: US 2002/0059380 A1
(43) Pub. Date: May 16, 2002

(54) EVENT-BASED MESSAGING

(76) Inventors: ALEXANDROS BILIRIS, CHATHAM, NJ (US); ROBERT E. GRUBER, SUMMIT, NJ (US); GISLI HJALMTYSSON, GILLETTE, NJ (US); HOSAGRAHAR VISVESVARAYA JAGADISH, ANN ARBOR, MI (US); MARK ALAN JONES, NEW PROVIDENCE, NJ (US); INDERPAL SINGH MUMICK, BERKELEY HEIGHTS, NJ (US); EUTHIMIOS PANAGOS, NEW PROVIDENCE, NJ (US); DIVESH SRIVASTAVA, SUMMIT, NJ (US); DIMITRA VISTA, PHILADELPHIA, PA (US)

Correspondence Address: CHRISTOPHER A HUGHES, MORGAN & FINNEGAN, 345 PARK AVENUE, NEW YORK, NY, 10154

(21) Appl. No.: 09/215,449

(22) Filed: Dec. 17, 1998

(51) Int. Cl. G06F 15/16

(52) U.S. Cl. 709/206

(57) ABSTRACT

A messaging system that handles messages of any kind, and a method of operation thereof, in which advanced messaging services can be implemented for multiple users, across multiple mail clients, in a more flexible and less limited fashion than previous messaging systems. The messaging system includes a plurality of messaging entities together having a state. An event supplier detects a change in the state of the messaging entities and generates an event announcement. An event manager receives the event announcement and generates an event notification. An event consumer receives the event notification and examines or manipulates at least one messaging entity.

### FIELD OF THE INVENTION

The present invention relates to a messaging system and a method of operation thereof, in which advanced messaging services can be implemented in a more flexible and less limited fashion than in previous messaging systems.

### BACKGROUND OF THE INVENTION

Recent trends in the use of messaging for marketing, electronic commerce, information exchange, and entertainment have resulted in a vast increase in the number of messages being sent and received, necessitating significant performance improvements in the underlying infrastructure of messaging systems. The large volume of messages arriving in user mailboxes, and the large variety of purposes for which messages are exchanged, has the natural consequence that users want richer facilities to control and manipulate this information conveniently.

A messaging system that addresses the above challenges must depart from the traditional, monolithic, tightly integrated approach followed by most existing messaging systems. In particular, it should provide a modular infrastructure that supports the rapid development of advanced messaging services (e.g., return receipt on message access, workflow routing, virtual mailboxes). New messaging services often require knowledge of internal actions performed by the core components of the system. However, the modular design of the system should not be compromised: creation of a new service cannot require modifications to the core components, and replacing one implementation of a core facility with another should have only local impact.

An event service is a key technology for meeting the above goals and exposing internal actions in a standard event format. An event corresponds to a detectable change of state in the messaging system. For example, a message being added to, or deleted from, a folder is an event; the creation of a new folder is an event; etc. Events report abstract descriptions of internal state changes and do not need to change with new implementations.

Existing messaging systems support rudimentary event services, if any at all. In particular, virtually all existing messaging systems support one event type: a new message in the mailbox of a user. New services can be notified about this event by using special configuration files that, in most cases, are stored in the home directory of the user whose mailbox is updated—the “forward” file in UNIX is an example of such a configuration file. Since this concept is associated with users, a service for many users would require installation of a configuration file for each user.

In some cases, special system configuration files may be altered to offer some special capabilities to both groups of users and services. However, this is difficult to do and requires deep knowledge of the internal working of the particular system.

On the other hand, existing mail clients (e.g., Eudora, Zmail, Netscape Messenger, Microsoft Outlook Express) support rules, which are built-in event-action facilities, for automated mail management. Basically, rules can do automatically anything that a user could do manually. For example, rules can forward messages, create and send out messages on a regular basis, filter messages according to certain criteria, etc.

However, these rules are both mail client specific and, in many cases, machine specific. Consequently, they are not valid across different mail clients or across different computers, even when these computers have the same mail client installed. Furthermore, these rules apply to only one user.

In order to implement advanced services, such as return receipt on message access, special user-level notification on new message arrival or declarative mailbox maintenance, the same set of rules must be installed on all possible mail clients users may use, and the same configuration should be used across all machines used by these users. Such installation is difficult and costly at best; it may even be impossible due to the lack of interoperability between mail clients.

### SUMMARY OF THE INVENTION

The present invention is a messaging system that handles messages of any kind, and a method of operation thereof, in which advanced messaging services can be implemented for multiple users, across multiple mail clients, in a more flexible and less limited fashion than previous messaging systems.

The messaging system includes a plurality of messaging entities together having a state. An event supplier detects a change in the state of the messaging entities and may generate an event announcement. An event dispatcher receives the event announcement and, based on the filters registered by services that are interested in these events (event consumers), may generate an event notification. When an event consumer receives an event notification, it may examine or manipulate at least one messaging entity.

The event dispatcher accepts event descriptions from core components or existing messaging services, called suppliers, and delivers corresponding event notifications to services interested in these events, called consumers. The act of supplying an event is asynchronous and decoupled: suppliers of events do not block until notifications are sent to all interested consumers and, also, suppliers do not have to be aware of the consumers of their events and vice versa.

When core components and existing messaging services announce important events, additional services can be built to perform actions based on receiving notifications about these events. Thus, value-added services can be built without requiring any changes to the original core components and services. For example, assume that a message store supplies an event when it stores a new mail message and, in addition, an mail-processing server supplies an event when a change occurs in the mail-processing flags associated with a message. Given these events, a new service can be built that sends a response to the sender of a message when this message is accessed by one of its recipients.

Furthermore, if services interact via events and are designed to handle events from many event suppliers, another supplier of a given event type can be introduced without changing any existing services. The removal of a given event supplier can be transparent as well.

An event service also provides useful support for carrying out trial runs of new services where these trials are allowed to use released services in a controlled fashion. Advantages to using the released services as part of a trial include: (a) released services and data need not be duplicated, (b) events generated by released services are available to trial services, and (c) it is possible to observe the impact of the new events generated by trial service on the released services without impacting them negatively.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is a logical block diagram of a messaging system, according to the present invention.

FIG. 2 is a data flow diagram of event driven messaging, implemented in the messaging system of FIG. 1.

FIG. 3 is a more detailed block diagram of an event manager shown in FIG. 2.

FIG. 4 is an exemplary block diagram of a messaging server, in which the messaging system of FIG. 1 is implemented.

FIG. 5 is a flow diagram of an event-driven messaging process, implemented in the messaging system of FIG. 1.

### DETAILED DESCRIPTION OF THE INVENTION

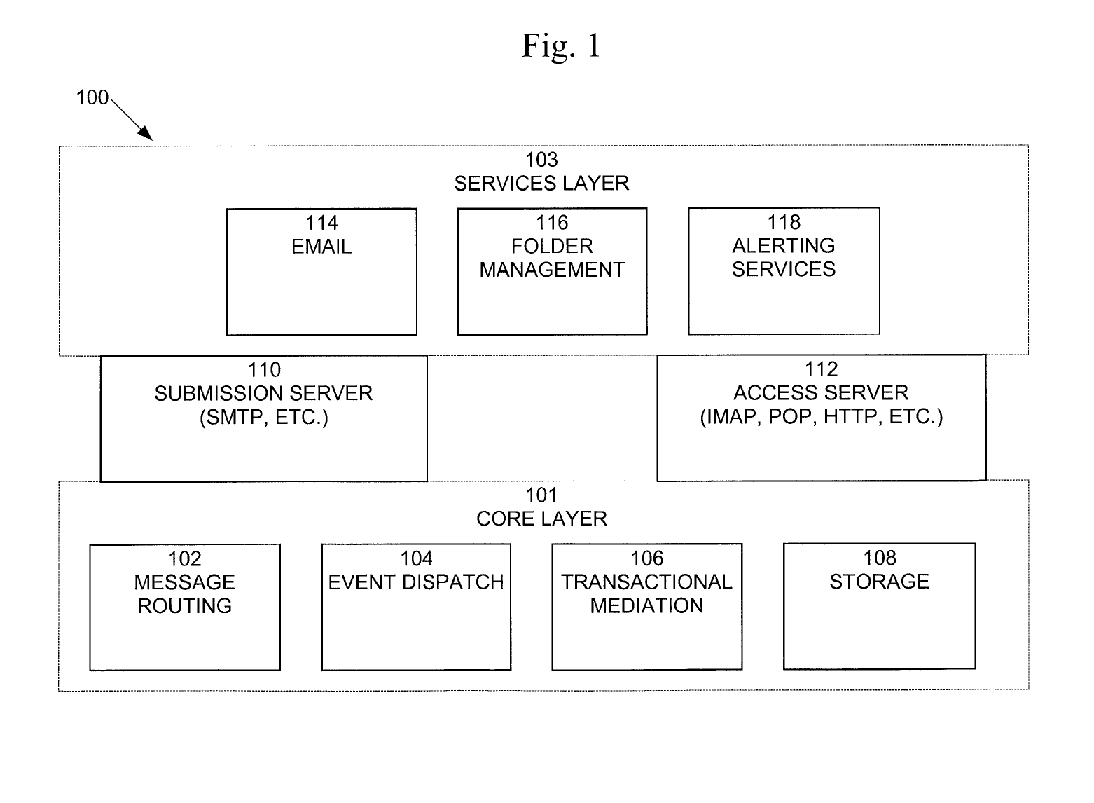

A messaging system 100, according to the present invention, is shown in FIG. 1. A messaging system is a system for the storage, management, and retrieval of messages. A message is a piece of data created and posted by a sender and intended for one or more recipients.

The messaging system of FIG. 1 has two layers: the core layer 101 and the services layer 103. The core layer provides core messaging facilities, such as message routing 102, event dispatch 104, transactional mediation 106 and multiple, possibly heterogeneous data stores 108: for depositing and retrieving message contents; for managing user folders; for representing and managing the semi-structured nature of messages; and for maintaining information about users and user groups. In addition, the core layer consists of a submission server 110 that can receive messages from sending clients, and an access server 112 that provides access to messages for a receiving client.

The services layer includes a variety of services built upon the basic functionality of the core layer. Examples of such services, shown in FIG. 1, include traditional e-mail 114, folder management for declaratively specified folders 116, user-specific alerting services 118, and so on.

### A Conceptual Model

The fundamental entity in a messaging system that supports electronic mail is the message. A message consists of (i) one or more header fields, like ‘To’, ‘Date’, ‘Subject’ and ‘From’, some of whose values are structured, and some of whose values are unstructured and (ii) a body, which is typically unstructured. For conceptual simplicity, we model a message as a set of attribute/value pairs, one for each header field in the message, and one for the entire content (both header and body) of the message. Additional attribute/value pairs may also be associated with messages.

Messages are typically sent to users, or user groups, and these are part of our conceptual model as well. Users and user groups are also naturally modeled as a set of attribute/value pairs. For example, a user can be modeled by specifying values for attributes such as ‘givenName’ and ‘e-mail’. User groups may have attributes for their name, for specifying membership in the group, and so on.

Messages sent to users or user groups get deposited in mailboxes or folders, and users access their messages by examining folders. A folder can be viewed as consisting of a set of messages, as well as a set of sub-folders. A folder has attributes as well, such as its date of creation, the number of messages in it currently, and so on.

Often, attribute/value pairs need to be associated not just with individual messaging entities, but with relationships between messaging entities. For example, a message can be deposited in multiple folders, and when a message is read in a folder, replied to, or deleted from a folder, this fact can be recorded as the value of a “per-message, per-folder” attribute. Such attributes are not restricted to a predetermined set either.

### Core Layer

Message Router

The message router 102, shown in FIG. 1, accepts messages from the submission server 110 and either forwards them to an external mail system or to the appropriate component(s) of the storage system. Typically, the appropriate components will be a message store for the message itself, a folder store for the intended recipient's “inbox”, and zero or more additional attribute stores. The message router function is traditionally performed by a “Message Transfer Agent”(MTA).

Storage

Messaging entities, which we require to have unique identifiers, the various relationships between the entities, and the attribute/value pairs associated with these entities and relationships, are uniformly represented in one or more attribute stores. Every store in the network is modeled as an “attribute store”, which maintains a relationship between one or more identifiers and a set of attributes. The basic access functions supported are to return identifiers matching a specified attribute value and to return all attributes given an identifier key. This simple model is used as the common denominator to tie multiple heterogeneous stores into a single framework via a common, generic application programming interface (API).

Message Store

A message store maintains the value of the most important attribute of a message, namely its content. The message content is treated as an arbitrary stream of bits by the message store: semantics are the provenance of higher level services. When a new message for a local recipient arrives in the messaging system, the message is passed to a message store where it is stored, given a message identifier, and then “exposed” through the transaction manager to any core services that may wish to extract and index message attributes. Finally, a message arrival event is signaled outside the core layer for consumption by services interested in this event.

Folder Store

The term folder is used in our system to refer to sets of messages, and sub-folders, that have been organized for convenience of access by a user. A user may specify multiple folders as a way of classifying messages. In contrast with traditional folders, however, a folder in our system typically contains only the message identifiers of its messages. This design has several benefits. Since the folder store does not have to handle large messages or store complex message types, it can be quite light-weight. The separation of the message store from the folder store is also crucial for permitting late binding of message content to folders.

Directory

Our messaging system assumes the availability of a directory facility, with information describing user entities, which are generally end-users or user groups, but could also represent network devices (e.g., printers), or services (such as newsgroups and mailing lists). User entities in the directory have attributes, some of which are mandatory while others are optional. The directory provides access to its entity attributes using the Lightweight Directory Access Protocol (LDAP) standard.

Default Attribute Store

The majority of the attributes to be stored in a messaging system tend to be fairly simple and quite numerous, including flags that indicate message state, and so forth. All such attributes are managed by a default attribute store. While “special” attributes, such as message content or full-text indices, may be more effectively stored in appropriate specialized stores, the default store provides at least one simple way of storing any attribute at all.

Transactional Mediators

The messaging system described here includes multiple attribute stores, with individual stores implemented in very different ways. A typical configuration should be expected to have at least an LDAP directory, a file system, and an RDBMS. In general, these system components differ with respect to their APIs, their capabilities, and their performance characteristics. To manage such implementation components, a “transactional mediator” is used as a “wrapper” around each system component. A transactional mediator serves the needs of API conformance and query optimization. In addition, each transactional mediator provides transactional support to ensure consistency in the presence of concurrent activity and to facilitate recovery in the presence of failures.

Event Dispatch

An event is a detectable change of state in the messaging system of the present invention. For example, a message being added to, or deleted from, a folder is an event; the creation of a new folder is an event; and so on. In the present invention, events are a mechanism used by the core layer to notify the services of the upper layer that something of interest has happened. Upper layer services may then execute actions in response to events, such as logging of accounting information for billing purposes.

An event dispatcher is employed by the messaging system described in the present invention. The event dispatcher accepts event descriptions from the core components, called suppliers, and delivers corresponding event notifications to services interested in these events or combinations of these events, called consumers. ith the event dispatcher, an event supplier specifies the kinds of events it will supply, while a consumer specifies the kinds of events it is interested in. When an event is handed to the event dispatcher by a supplier, the dispatcher delivers an event notification to only interested consumers avoiding wastage of important shared resources, such as network bandwidth.

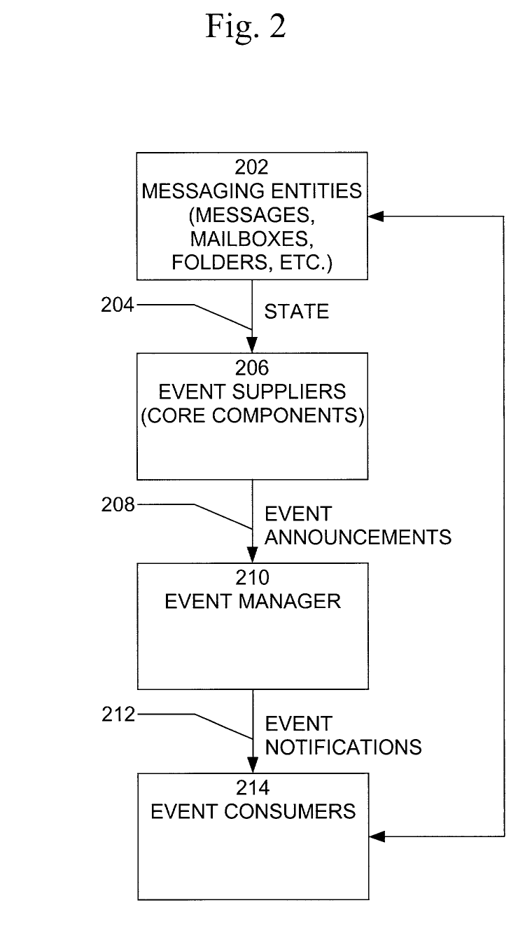

A data flow diagram of event-driven messaging, implemented in the messaging system 100, is shown in FIG. 2. Messaging entities 202 includes fundamental objects that are handled and maintained by the messaging system, such as messages, mailboxes, folders, attributes, etc. The values of each of these messaging entities at a given time, taken together, is the state 204 of the messaging system at that time. The state 204 of the messaging system is managed by event suppliers 206, which are core components that examine and manipulate the values of the messaging entities. The event suppliers 206 detect changes in the state of the messaging system and generate events based on the detected changes.

Event suppliers 206 transmit event announcements 208 to event manager 210 based on the generated events. For each received event announcement 208, event manager 210 generates the appropriate event notifications 212 and transmits the event notifications 212 to the appropriate event consumers 214. An event consumer is a software program or routine that responds to event notifications. Upon receiving an event notification, the notified event consumers 214 may examine and manipulate messaging entities 202, in order to implement the desired services.

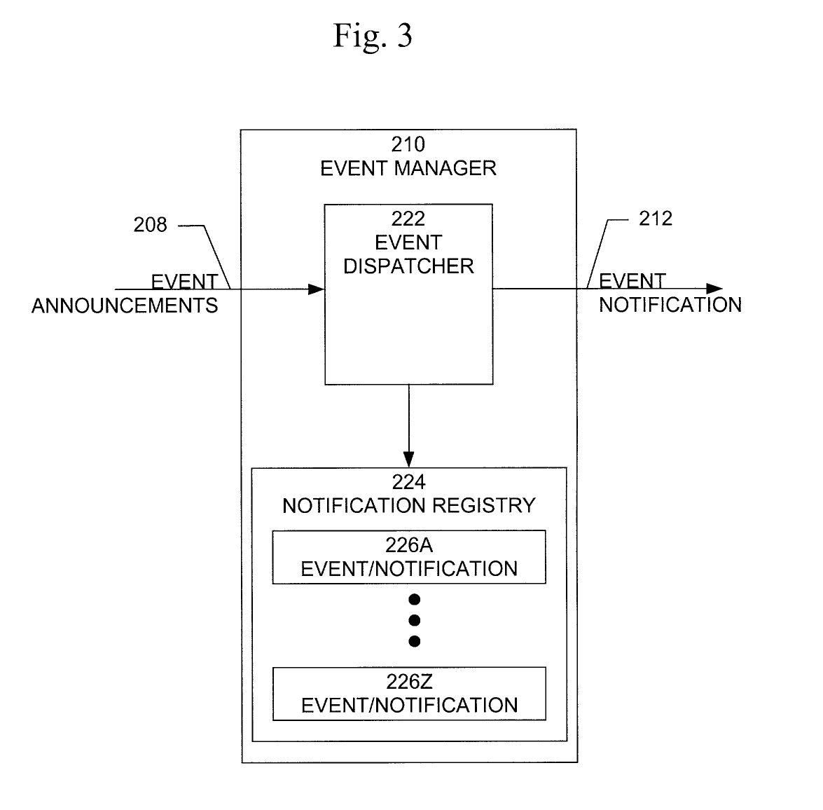

The event manager 210, of FIG. 2, is illustrated in more detail in FIG. 3. Event manager 210 includes an event dispatcher 222 and a notification registry 224. Event announcements 208 generated by suppliers are received by the event dispatcher 222. The event dispatcher then uses the notification registry 224 in order to notify the interested event consumers. Notification registry 224 includes a plurality of event/notification entries 226A-Z. Each entry 226 includes a field specifying the event or combination of events to which the entry corresponds and one or more fields specifying the event consumers that are to be notified upon occurrence of the specified event or combination of events. Based on the received events, event dispatcher 222 selects the appropriate entries in the registry and generates appropriate notifications 212.

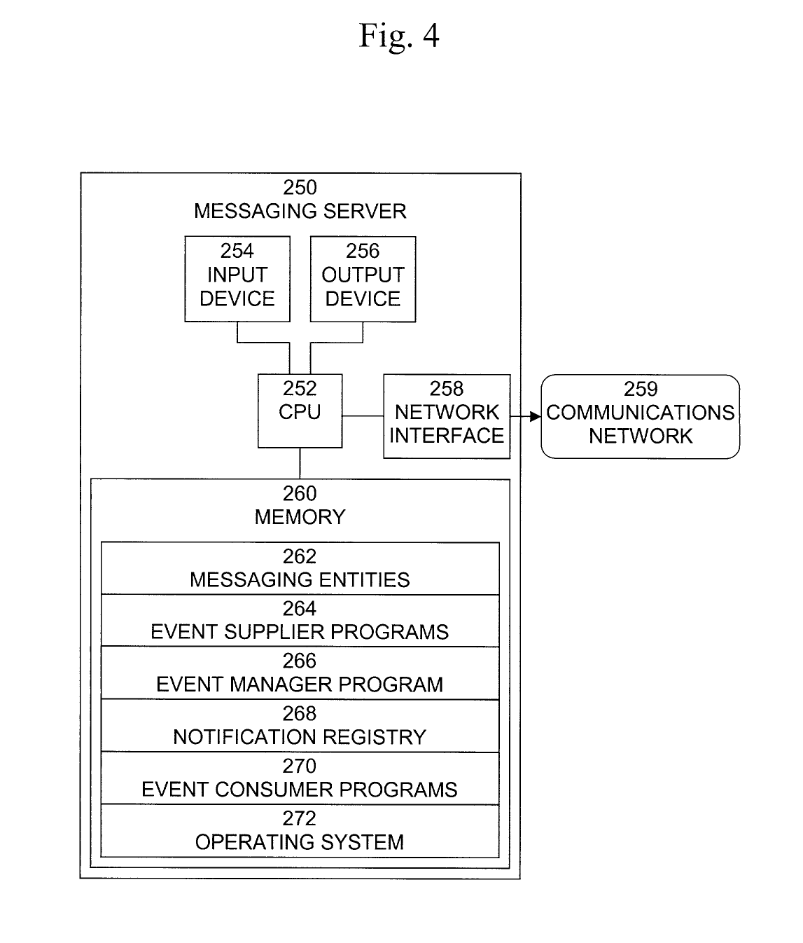

The messaging system of the present invention includes one or more messaging servers 250, shown in FIG. 4. Messaging server 250 includes central processing unit (CPU) 252, which is connected to input device 254, output device 256, network interface 258 and memory 260. CPU 252 may comprise a microprocessor, for example, an INTEL PENTIUM processor, or CPU 252 may comprise a mini-computer or mainframe processor. Input device 254 allows input information to be entered and may comprise a keyboard, a mouse, a floppy disk drive, a tape drive, and/or other removable media drive or interchange device. Output device 256 allows the output of provisioning information generated by messaging server 250 and typically comprises a high-speed printer. Network interface 258 couples messaging server 250 to communications network 259 and allows an alternate path for input or output of information. Communications network 259 may be, for example, a local or wide area network, the public switched telephone network, or the Internet. Network interface 258 may comprise a conventional modem or a local/wide area network adapter, depending upon communications network 259. Memory 260 may include devices such as random access memory or read only memory, which store data and instructions for execution by CPU 252. Memory 260 may also include devices such as magnetic disk drives, optical disk drives and tape drives, which store data and program instructions used by the present invention.

Memory 260 includes messaging entities 262, event supplier programs 264, event manager program 266, notification registry 268, event consumer programs 270 and operating system 272. Messaging entities block 262 includes storage for messages, mailboxes, folders, attributes, etc. Event supplier programs 264 comprises program instructions that are executed by CPU 252, and which implement core services which detect changes in the state of the messaging system and generate events based on the detected changes. Event manager program 266 comprises program instructions that are executed by CPU 252, and which receives event announcements, generates the appropriate event notifications and transmits the event notifications to the appropriate event consumers. Notification registry 268 is used by event manager program 268 to notify the interested event consumers. Event consumer programs 270 comprise program instructions that are executed by CPU 252, which may examine and manipulate the messaging entities, in order to implement the desired services.

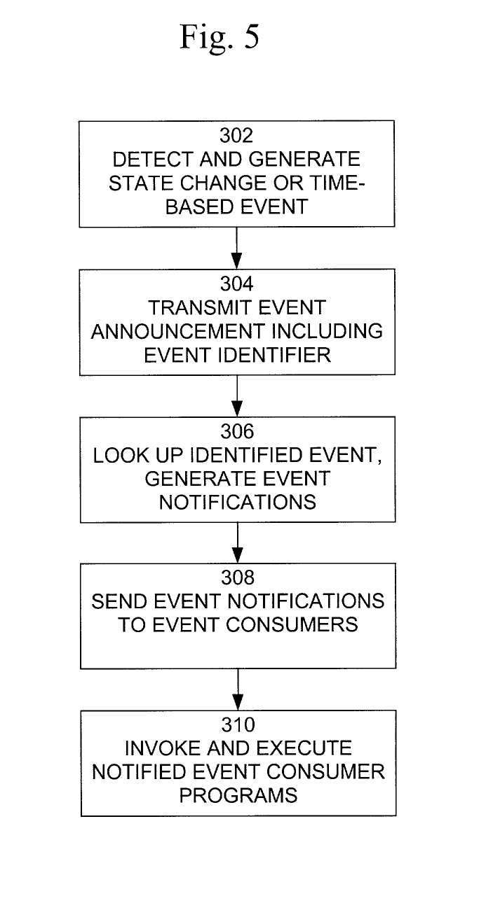

A flow diagram of an event-driven messaging process, implemented in messaging system 100, is shown in FIG. 5. The process begins with step 302, in which event suppliers 206, which are existing services or core components that examine and manipulate the values of the messaging entities, detect and generate a state change or a time-based event. Two categories of events are generated in the messaging system of the present invention: time-based and state-based. Time-based events are generated with the passage of time. For example, a message may have an expiration time of “2:00:00 p.m., Oct. 18, 1997”. This expiration time is recorded at a time-based alarm generation facility at the time the message is entered into the system. When this time arrives, an event is generated by the alarm generator, and it may be consumed by a garbage collection service. Periodic events (e.g., events generate once per month) are also supported.

State-change events are generated when a change in the state of the system is detected by the core software layers, i.e., a new message is received, a message is read, a folder is accessed or updated, a message is deleted, etc. A folder management service can maintain correct contents for a declaratively-specified folder by registering for new mail events and other relevant state-change events.

In step 304, event suppliers 206 transmit an event announcement including an identifier of the generated event to event manager 210. The event announcement includes information relating to the context of the generated event. This context contains enough information to allow services to both identify the particular entity (message, folder, etc.) involved in the event and also to access the entity in question for retrieving more information, if needed.

In step 306, event manager 210 looks up the identified event in notification registry 224, determines the consumers that are interested in that event and generates event notifications for those consumers. The event notifications include the context information of the event, which is passed to the event consumers. The interested event consumers are those that are specified in the event/notification entries in notification registry 224. In step 308 the event notifications are transmitted to the interested event consumers. In step 310, the notified event consumer programs are invoked and executed in order to implement the desired services.

The event mechanism employed in the messaging system of the present invention is general-purpose, and it is more powerful than the event facilities supported by existing electronic mail systems. Finally, this event notification mechanism is different from the Event-Condition-Action mechanism provided by active database management systems, in that the actions executed are not internal to the “database”, but rather invoked at a higher layer service.

Examples of types of events that are generated by the core layer of the system include:

Message Arrival: This event is generated when a new message is received by the submission server, which is shown as box 110 in FIG. 1.

Message Delivery: This event is generated when a new message is delivered to a mailbox.

Message Queuing: This event is generated when a message has to be queued and forwarded by the message routing box 102, shown in FIG. 1, to an external messaging system or another instance of our system.

Message Movement: This event is generated when a message is copied from one folder to another or moved from one folder to another one.

Message State Change: This event is generated when the state of a message changes. For example, when a message is read, deleted, or replied, a state change event is generated.

Folder Creation: This event is generated when a folder is created.

Folder Deletion: This event is generated when an existing folder is deleted.

Folder Rename: This event is generated when an existing folder is renamed.

Folder Access: This event is generated when a folder is being opened or closed.

### SERVICES LAYER

The motivation behind the architecture of the core described thus far is to facilitate the construction of services on top of this core. These messaging services and features are of direct utility to an end-user. Examples of such services include the following:

Traditional E-mail

Implementing traditional Internet e-mail service is easy, as the core directly supports most of the required functionality. The e-mail service consists of three components; user registration, sending messages, and folder access. During registration, the e-mail service creates an entry in a directory containing the recipient's mail-Id and associated (user) information. In addition the core creates a (mailbox) folder for the user. Messages are sent using an SMTP client. The message router 102 shown in FIG. 1 stores the message in the message store, and the e-mail service updates each recipient's folder with the identifier of the new message. Messages are accessed using standard clients, say POP3, at which time message identifiers are dereferenced by the access server 112, and actual message bodies are shipped to the client.

Folder Management

Whereas the contents of traditional message folders are enumerated explicitly by the owner, a “declaratively specified folder” is defined by the predicate that the corresponding messages should satisfy. Examples of folder definitions include: (1) the set of all messages from an enumerated or declaratively specified set of individuals, (2) the set of all messages received by the user in the past week, (3) the set of all messages explicitly tagged by the user as being about some particular topic, and so on.

The folder management service is responsible for both creating and manipulating declarative folders on behalf of users and, also, for computing their contents upon user access. To improve the performance of access, the service may materialize and maintain folders in the folder store. The maintenance of folders may be either immediate, upon receipt of new messages by the messaging system, or deferred, upon access of the folder or some other policy used, e.g., once a day.

The folder management service is driven by events generated by the core components of the system. In particular, the service registers with the event dispatcher to receive notifications about message arrivals, message attribute modifications, folder access and folder modifications, among other events. Upon message arrival, the folder management service receives a notification that includes the message identifier and the recipient(s) of the message. If any recipient uses declaratively specified folders, the service may choose either to immediately examine the message or to store the notification for future processing.

Upon folder access, the folder management service receives a notification which includes the identifier of the folder. If the folder is defined declaratively, the service takes responsibility to bring the folder contents up to date with respect to any past updates that affect the folder in question.

Alerting Services

An alerting service causes an alert to be sent to some or all of the recipients of a new message. The alerting service is “driven” by newly arrived message events, and it receives the list of recipients as part of the notification about the new message. Then, it locates the user profiles for recipients that have registered to be alerted and carries out the actions specified in these profiles. Possible actions include paging, faxing, automated phone calls, and pop-up message windows.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A messaging system comprising:
a plurality of messaging entities together having a state;
an event supplier operable to detect a change in the state of the messaging entities and generate an event announcement;
an event manager operable to receive the event announcement and generate an event notification; and
an event consumer operable to receive the event notification.

2. The system of claim 1, wherein the event consumer is further operable to examine or manipulate at least one messaging entity.

3. The system of claim 2, wherein the event manager is further operable to receive a plurality of event announcements and generate an event notification based on a combination of the event announcements.

4. The system of claim 6, wherein the event manager is further operable to generate a plurality of event notifications in response to an event announcement.

5. The system of claim 1, wherein the event manager comprises a notification registry, including a plurality of event/notification correspondence entries, and an event dispatcher operable to receive an event announcement and to generate an event notification in response to the event announcement based on an entry in the notification registry.

6. The system of claim 4, wherein the event consumer is further operable to examine or manipulate at least one messaging entity.

7. The system of claim 5, wherein the event manager is further operable to receive a plurality of event announcements and generate an event notification based on a combination of the event announcements.

8. The system of claim 6, wherein the event manager is further operable to generate a plurality of event notifications in response to an event announcement.

9. The system of claim 4, wherein the state of the messaging entities includes a time.

10. In a messaging system comprising a plurality of messaging entities together having a state, a method of messaging comprising the steps of:
detecting a change in the state of the messaging entities and generating an event announcement;
receiving the event announcement at an event manager and generating an event notification; and
receiving the event notification at an event consumer.

11. The method of claim 10, further comprising the step of:
examining or manipulating at least one messaging entity, in the event consumer.

12. The method of claim 11, wherein the steps of receiving the event announcement at an event manager and generating an event notification comprises the steps of:
receiving a plurality of event announcements and generating an event notification based on a combination of the event announcements.

13. The method of claim 12, wherein the step of generating an event notification includes the step of generating a plurality of event notifications in response to an event announcement.

14. The method of claim 10, wherein the step of receiving the event announcement at an event manager and generating an event notification comprises the steps of:
receiving the event announcement at an event dispatcher; and
generating an event notification in response to the event announcement based on an entry in a notification registry, the notification registry including a plurality of event/notification correspondence entries.

15. The method of claim 14, further comprising the step of:
examining or manipulating at least one messaging entity, in the event consumer.

16. The method of claim 15, wherein the steps of receiving the event announcement at an event manager and generating an event notification comprises the steps of:
receiving a plurality of event announcements and generating an event notification based on a combination of the event announcements.

17. The method of claim 16, wherein the step of generating an event notification includes the step of generating a plurality of event notifications in response to an event announcement.

18. The method of claim 17, wherein the state of the messaging entities includes a time.
